(19) United States
(12) Patent Application Publication
(10) Pub. No.: US 2008/0138054 A1
(43) Pub. Date: Jun. 12, 2008

(54) MODULAR HEATED TOWEL RAIL

(75) Inventor: David Charles Weir Short, Auckland (NZ)

Correspondence Address: DARBY & DARBY P.C., P.O. BOX 770, Church Street Station, New York, NY, 10008-0770, US

(73) Assignee: D C Short Limited, Panmure Auckland (NZ)

(21) Appl. No.: 11/944,893

(22) Filed: Nov. 26, 2007

(30) Foreign Application Priority Data
Nov. 24, 2006 (NZ) 551614

(51) Int. Cl. H05B 3/78

(52) U.S. Cl. 392/485

(57) ABSTRACT

A member for an electrical heating apparatus, the member comprising coupling means for structurally and electrically coupling one or more elements to the member. The invention further provides a cooperating element and an apparatus including one or more of the members and/or one or more of the elements. An electrical heater is also provided, the heater having a plurality of points for connecting to an electrical power supply.

### FIELD OF THE INVENTION

The invention relates to an electrical heater. More particularly, the invention relates to a modular heated towel rail, such as for use in a bathroom, and constituent components thereof.

### BACKGROUND

Various heated towel rails presently exist including hydronic and electrical resistance wire heating types. Both types usually include a series of generally horizontal tubes connected (typically by welding) to two vertical tubes to form a ladder-like construction. In the case of hydronic types, the tubes include an inlet for receiving hot liquid (typically, hot water) from a heater/boiler and an outlet for allowing the liquid to pass therethrough, such that it may possibly be circulated back to the heater and provided again to the inlet. According to some arrangements, the tubes are configured to form a serpentine passage so as to aid the flow of the liquid. Electrical resistance wire heating types tend to have a similar construction but, instead of allowing liquid to flow through the tubes, electrical resistance wire is provided therein and coupled to an electrical power supply. Application of electrical current to the wire causes heat to be generated.

Heretofore, consumer choice has been limited to the specific dimensions of towel rails provided by manufacturers. This not only affects the consumer but also manufacturers and stockists because they must store rails of each size. This problem is exacerbated by the fact that towel rails generally have some form of plating or high quality finish that is of aesthetic importance to the consumer but easily marked. This means that each rail must be packaged individually, and to a reasonable level, to ensure that there is no damage thereto.

Furthermore, prior constructions of electrically heated towel rails have limited the point of connection to the electrical mains supply to the bottom left or right of the towel rail (but not both sides), generally through an opening at the bottom of one of the vertical tubes. Thus care must be taken by purchasers to ensure that the “correct sided” rail is purchased and the fitter must ensure that the wiring is correct for the particularly sided rail that is purchased. Clearly, frustration may be caused where a mistake is made by the purchaser or the fitter, and this may possibly necessitate the return and replacement of the rail.

### SUMMARY OF THE INVENTION

It is an object of the invention to provide an improved electrical heater.

Alternatively, it is an object to provide at least a useful choice to existing apparatus.

According to a first aspect of the invention, there is provided a member for a heating apparatus, the member comprising coupling means for structurally and electrically coupling one or more elements to the member.

Preferably, the member comprises means for connecting to an electrical power supply.

Preferably, the member is elongate.

Preferably the member comprises first and second ends.

Preferably, the means for connecting is provided proximate the first end.

More preferably, means for connecting to an electrical power supply are provided proximate the first and second ends.

Preferably, the member comprises means for conducting electrical current.

Preferably, the means for conducting is electrically coupled to the coupling means and the means for connecting.

Preferably, the means for conducting runs substantially the entire length of the member.

According to a second aspect, them is provided an element for a heating apparatus, the element comprising means for cooperating with the coupling moans of the first aspect to facilitate the structural and/or electrical coupling of the element to one or more said members.

Preferably, the element is elongate and/or arcuate.

Preferably, the element comprises first and second ends.

Preferably, the means for cooperating is provided proximate said first and/or said second end.

Preferably, the element comprises resistance wire heating means.

Preferably, the resistance wire heating means is provided along substantially the entire length of the element.

Preferably, the resistance wire heating means is electrically coupled to the means for cooperating.

More preferably, the element comprises said means for cooperating proximate the first and second ends thereof and the resistance wire heating means is electrically coupled to the means for cooperating therebetween.

Alternatively, the means for cooperating proximate the first end is adapted to facilitate structural and electrical coupling of the element to a first said member and the means for cooperating proximate the second end is adapted to facilitate structural coupling of the element to the first said member or a second said member. According to such embodiments, preferably, the resistance wire heating means is electrically coupled to the means for cooperating at only the first and of the element, such that the element is electrically and structurally coupled to a member at a first end thereof and only structurally coupled to a member at the second end thereof. More preferably, first and second ends of the resistance wire heating means are electrically coupled to the moans for cooperating at only the first end of the element, with a central portion of the resistance wire heating means being distal therefrom and preferably proximate the second end of the element. Preferably, the resistance wire heating means forms a loop inside the element.

According to a third aspect, there is provided an apparatus comprising at least one member of the first aspect and one or more elements of the second aspect.

More particularly, according to an embodiment of the third aspect, there is provided an apparatus comprising a first member; one or more elements; and means for structurally and electrically coupling the one or more elements to the first member.

Preferably, the apparatus comprises a second member and means for structurally and electrically coupling the one or more elements to the second member.

Preferably, the first member is arranged to couple to a first end of each of said one or more elements and the second member is arranged to couple to a second end of each of said one or more elements.

Preferably, each said one or more elements is adapted to electrically and structurally couple to the first member and to structurally couple to the second member.

According to a fourth aspect, there is provided an electrical heater, such as a towel rail, comprising a plurality of points at which the heater may be connected to a power supply.

Embodiments of the fourth aspect may be used in combination with one or more of the first through third aspects of the invention.

Further aspects of the invention, which should be considered in all its novel aspects, will become apparent to those skilled in the art upon reading the following description which provides at least one example of a practical application of the invention.

### BRIEF DESCRIPTION OF THE DRAWINGS

One or more embodiments of the invention will be described below by way of example only and without intending to be limiting with reference to the following drawings, in which:

FIG. 1 is an exploded view of an embodiment of the invention;

FIG. 2 is an enlarged view of portion A of the embodiment of FIG. 1;

FIG. 3 is an enlarged view of portion B of the embodiment of FIG. 1;

FIG. 4 is an enlarged view of portion C of the embodiment of FIG. 1;

FIG. 5 is a cross-sectional view of a portion of the embodiment of FIG. 1;

FIG. 6 is a similar view to that of FIG. 5 when the apparatus is assembled;

FIGS. 7 and 8 are alternative perspective exploded views of an alternative embodiment; and

FIG. 9 is a view of the embodiment of FIGS. 7 and 8 when assembled.

### DETAILED DESCRIPTION OF PREFERRED EMBODIMENTS

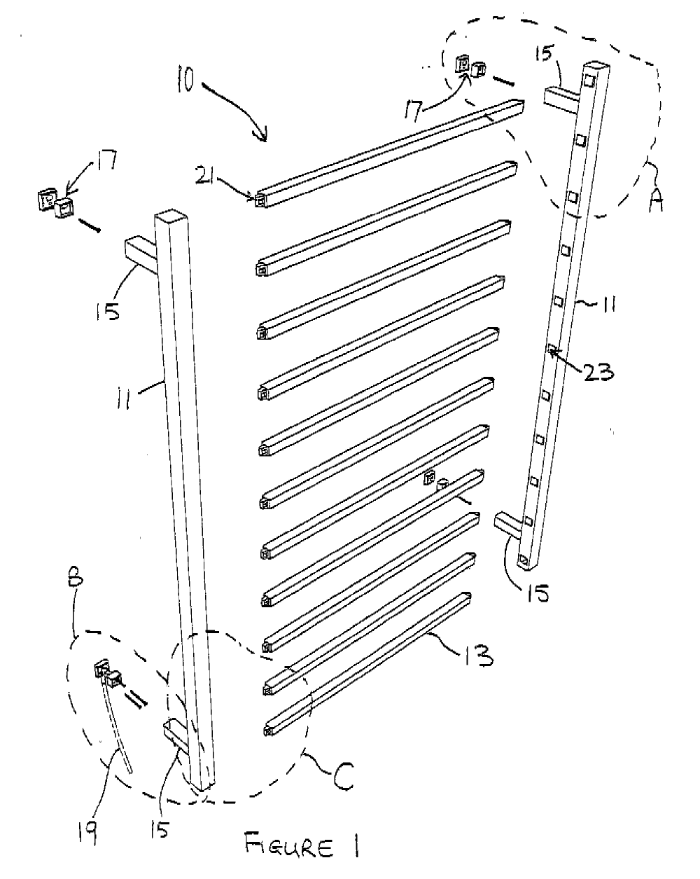

FIG. 1 shows an exploded or pre-assembled view of an apparatus 10 according to an embodiment of the invention. The apparatus includes upright members 11 with elements 13 extending therebetween. Preferably, members 11 and elements 13 comprise stainless tubing with a generally square or circular cross-section. Elements 13 house a resistance wire heating element (not shown). Wire heating elements are well known in the art and the skilled man may readily select a particular wire heating element that is suitable for a particular application without invention. Generally, the heating power or Wattage of each element 13 is proportional to its length as the length of the elements 13 will generally be proportional to the length of the wire heating elements therein.

Members 11 and elements 13 are shown in the Figures as having a generally square cross-section. While this cross-section is preferred, the invention is not limited thereto. Any cross-section may be used as would be apparent to those skilled in the art, including circular, oval or rectangular. Also, members 11 and elements 13 may have different cross-sections.

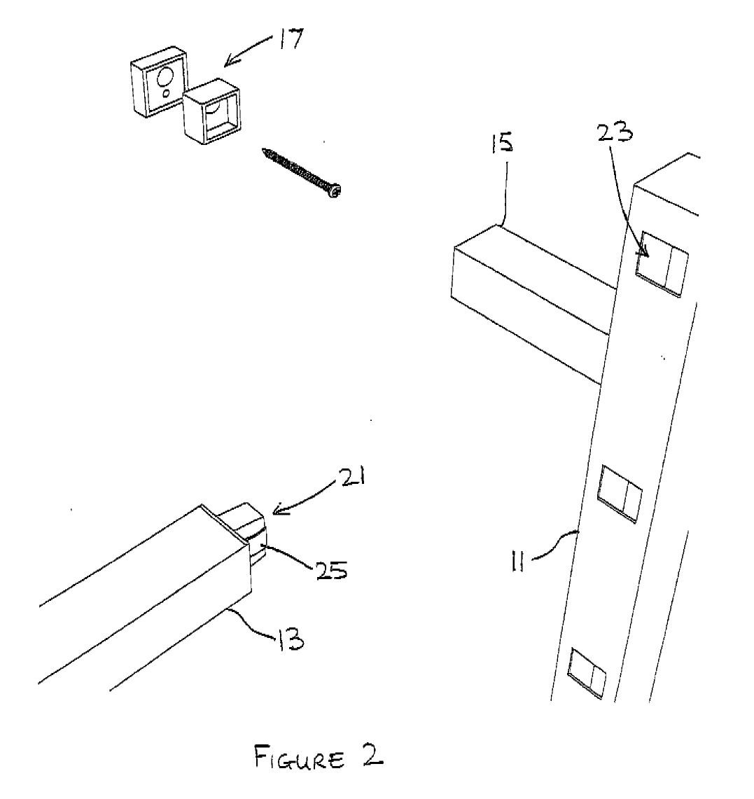

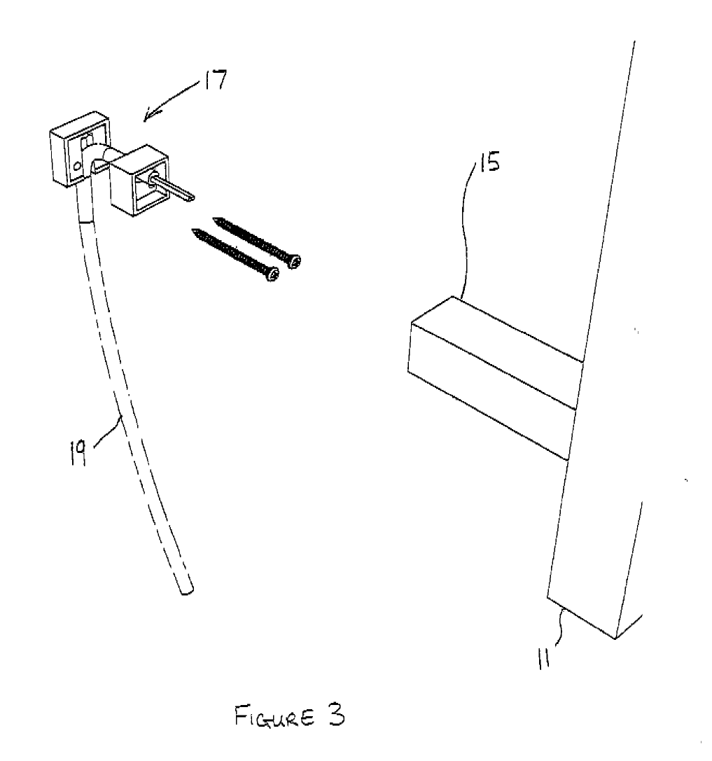

Apparatus 10 is preferably configured to be wall mounted and spacers 15 serve to provide a gap between the main body of apparatus 10 and the wall on which it is mounted. This facilitates the flow of air behind apparatus 10 to improve convective heat transfer and also enables articles, such as towels, to be placed on and supported by elements 13. Spacers 15, and hence apparatus 10, may be fixed to a wall using mounting means 17 (see FIG. 2 for enlarged view). Each mounting means 17 is preferably adapted to enable conductor 19 to pass therethrough to enable connection of the apparatus to an electrical power supply, such as the electrical mains, so that a current may be passed to the resistance wire heating elements inside elements 13 to generate heat (see FIG. 3 for enlarged view). Mounting means 17 is preferably adapted to grip conductor 19 to help reduce the likelihood of it becoming disconnected after installation. In alternative embodiments, only one or selected ones of mounting means 17 may be adapted to enable conductor 19 to pass therethrough. In such embodiments, each mounting means 17 is preferably adapted to engage any one of spacers 15, so that each is interchangeable and may be placed where required.

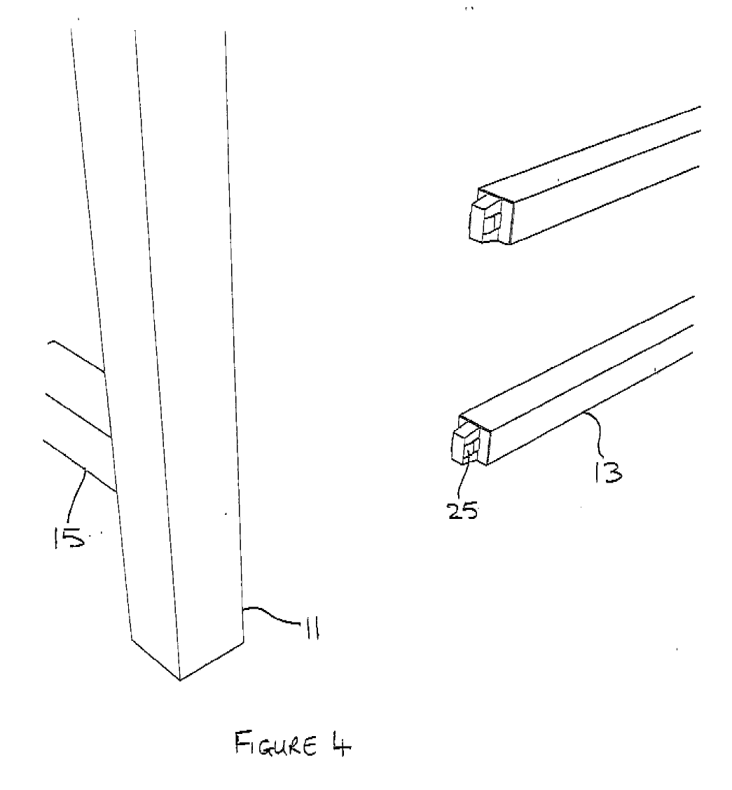

Coupling means 21, 23 and 25 is provided to enable each element 13 to be attached to one or more members 11. FIGS. 2 and 4 show enlarged portions of FIG. 1 illustrating coupling means 21, 23 and 25 in more detail. Coupling means 21, 23 and 25 includes at least one male component 21 provided on an element 13 and at least one cooperating female component 23 provided on a member 11 to which element 13 is to be coupled. It would be apparent to one of skill in the art that male components 21 may be provided on members 11 with corresponding female components 23 provided on element 13 and such alternatives are included within the scope of the invention.

During assembly, element(s) 13 is pressed against member 11 so that male component 21 engages female component 23, Coupling means 21, 23 and 25 may be adapted to provide for a snap fit such that male component 21 fixedly engages female component 23. According to the embodiment shown, female component 23 comprises an aperture provided in member 11 that is proportioned to receive a stub or plug provided in an end of element 13. Preferably, the stub is an injection moulded plastic stub. Retaining means 25, comprising a spring clip, holds the stub inside the aperture.

According to a preferred method of manufacture, the aperture is precision cut, such as by use of a laser, so that element 11 fits snugly inside the aperture and aids in improving the rigidity of apparatus 10 when assembled.

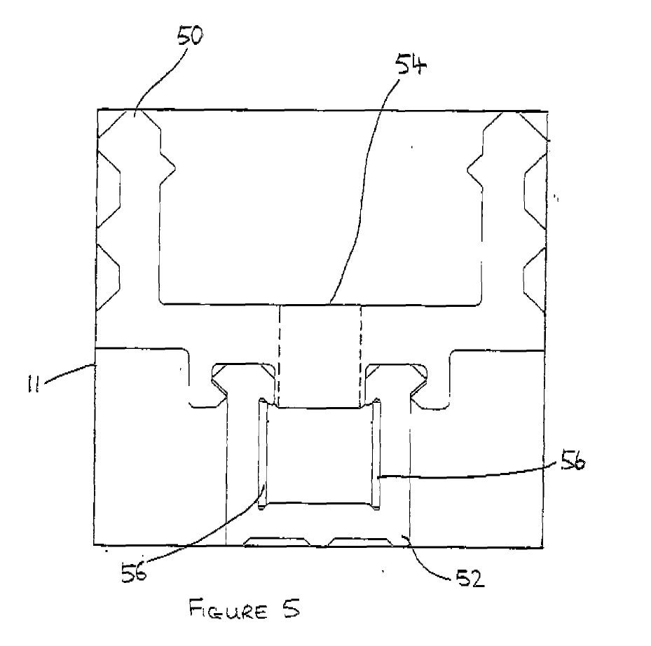

Coupling means 21, 23 and 25 not only structurally couple elements 13 to members 11 but also serve to provide an electrical coupling between the elements 13 and members 11 so that electrical current may flow therebetween. FIG. 5 shows a cross-sectional view through member 11 which illustrates internal components of member 11 that enable element 13 to be structurally and electrically coupled thereto. Each member 11 may have slotted therein first and second extruded sections 50 and 52. Extruded sections 50 and 52 are preferably comprised of a plastic. First extruded section 50 includes an aperture 54 that is positioned and dimensioned to allow a stub of an element 13 to pass therethrough when element 13 is pushed through a collinear aperture in member 11 outer housing (see FIGS. 1 and 2). Second extruded section 52 includes conducting strips 56 which preferably extend along substantially the entire length of member 11. According to a preferred embodiment, the ends of members 11 are capped and conducting strips 56 extend to within about 1 cm of the capped ends.

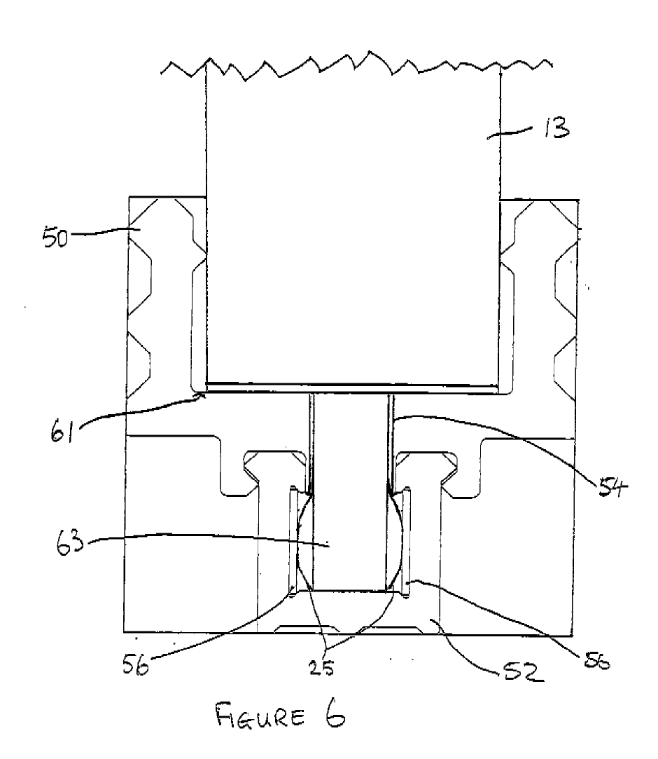

FIG. 6 shows a similar view to that of FIG. 5 but with an element 13 engaged with member 11. Element 13 is pushed into the aperture in member 11 until the end of the main body of element 11 abuts wall 61 of first extruded section 50. During this movement, stub 63 passes through aperture 54 in first extruded section 50 so that retaining means 25 come into electrical contact with conducting strips 56. Retaining means 25 preferably comprises arcuate conducting strips so that when element 13 engages member 11, retaining means 25 is distorted so as to ensure a good electrical contact with conducting strips 56 and also to provide resistance against element 13 becoming detached from member 11. According to at least one embodiment, retaining means 25 may be configured to provide a snap-fit when element 13 engages member 11 to provide for an improved fixing of element 13 to member 11. Other plug and socket type arrangements may be envisaged but the use of conducting strips is preferable because it enables elements 13 to be positioned anywhere along the length of the strip and not limited to the specific positioning of a plug/socket.

Retaining means 25 may be comprised of brass or nickel bronze and is preferably tin-plated. Retaining means 25 is electrically coupled to a resistance wire heating element inside element 13. Conducting strips 56 are preferably comprised of tin-plated copper. Each end of conducting strips 56 is preferably connected to insulated wire tails that protrude through spacers 15 proximate each end of member 11 and preferably for each member 11. The wire tails are preferably insulated using an injection moulded cap that may be fully formed over the exposed wire. During assembly, the fitter simply cuts off whichever insulated cap they wish and connects the now exposed wires to conductor 19 (see FIGS. 1 and 3), while the remaining wire tails remain safely insulated.

Preferably, the resistance wire heating element inside each element 13 forms a loop with each end of the resistance wire heating element being coupled to retaining means 25 at only one end of elements 13. Thus, electrical current may only flow through conducting strips 56 in one member 11, the particular member 11 depending on which end of elements 13 are plugged therein and which member 11 is coupled to an electrical power supply. In such embodiments, the other end of each of elements 13 may be formed of plastic or some other insulator.

This construction enables a tradesman or customer to purchase one type of towel rail, without concern for where the cable used to connect to a power supply may be required. For a ladder-like towel rail, bottom left or right or top left or right are all readily possible. It is important to note that this aspect of the invention may be used in isolation from other aspects of the invention. In particular, the multiple potential connecting points could be incorporated within more conventional heaters (namely towel rails) within the scope of the invention. The multi-point connection construction has the added benefits that manufacturers and retailers may hold reduced stock since it is not necessary to stock complete assembled heaters with connecting points for each position and that customer returns will be reduced due to mistakenly purchasing a heater with the connection point in the wrong position.

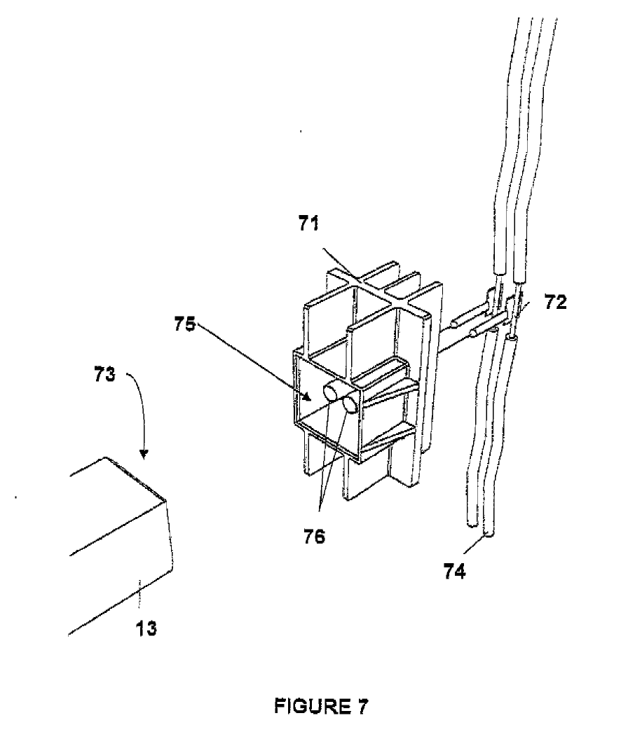

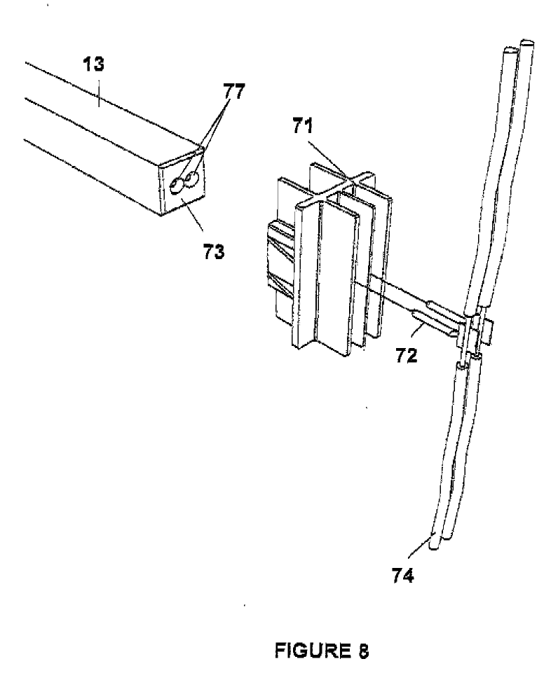

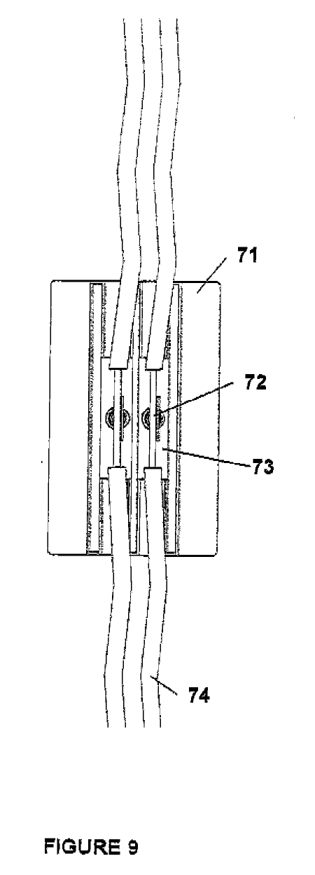

FIGS. 7 to 9 provide views of an alternative embodiment of means for structurally and electrically coupling an element 13 to a member 11. The alternative means include socket 71 (preferably formed by injection moulding), connector 72 and plug 73. Connector 72 is configured to couple to electrically conducting wiring 74 running inside a member 11. Preferably, wiring 74 runs along substantially the entire length of member 11. Connector 72 includes 2 pine for electrically connecting wiring 74 (which is coupleable to an electrical power supply) to the resistance wire heating element inside element 13, via plug 73.

During installation, one or more sockets 71 are joined to respective connectors 72 and driven inside member 11. According to preferred embodiments, sockets 71 are configured to form a tight interference fit when in position inside member 11. Socket 71 includes hollow portion 75 and hollow protrusions 76. Hollow protrusions 78 are configured to receive the pins of connector 72 and mate with apertures 77 provided in plug 73. Hollow portion 75 is configured to receive an end of element 13, preferably such that a tight interference fit is formed by the walls thereof.

According to preferred embodiments, sockets 71 have a length of approximately 50 mm although the invention is not limited thereto and does not preclude a member configured to run along substantially the entire length of a member 11 with one or more connection points provided along the length thereof.

Thus, according to embodiments of the invention there is provided a modular heater which may be readily assembled by an end consumer or a fitter without the need for any special tools. The modular arrangement provides for improved flexibility for consumers with the potential of providing any desired dimensions and/or configurations. This is made possible because members 11 and elements 13 are essentially the same for whatever size heater. All that is required is that they be cut to varying lengths. A fitter may then mix and match the particular lengths of members 11 and elements 13 to arrive at a desired configuration. Not only is it simple for manufacturers to make different sized heaters, but the invention still provides for reduced storage space required by stockists/retailers because it is possible to compactly store arrays of members and elements of different lengths in their pre-assembled form. Thus, the modular arrangement and the multi-point positioning for the electrical connection to the power supply via the wire tails both serve to reduce space and costs required for stocking inventory, without having to delay being able to supply goods to a purchaser. For example, elements 13 could be provided with lengths incrementally increasing at steps of 50 mm from 400 mm to 1200 mm and members 11 could be provided with lengths incrementally increasing at steps of 100 mm from 400 mm to 1800 mm. Note that these lengths and increments are illustrative only and others are within the scope of the invention. It would also be possible for bespoke heaters or towel rails to be made using specific dimensions provided by the purchaser.

According to preferred embodiments, elements 13 are electrically connected in parallel. This reduces the voltage required to power heaters configured in this way such that a 12 V supply may be sufficient. Thus, it is not necessary for embodiments of the invention to be mains powered. In fact, to meet relevant standards, according to a preferred embodiment, the power supply is an isolated 12 V AC or up to 30 V DC ripple-free separated extra low voltage (SELV) power supply.

Embodiments of the invention have been described in terms of generally ladder-like towel rails. Other configurations are within the scope of the invention. All that is essential is that elements 13 have a sufficient length so that the resistance wire heating element has a corresponding sufficient length to be able to generate the desired amount of heat for the particular application. For example, members 11 and/or elements 13 may be arcuate, members 11 and/or elements 13 may be oriented at any angle (not just vertical and horizontal, respectively), only a single member 11 may be used with looped elements 13 with each end of elements 13 coupling to a separate or the same connecting point on member 11, elements 13 may only have a member 11 coupled at one end thereof with electrical connections and conductors inside elements 13 and members 11 adapted to maintain proper current flow, or more than two members 11 may be used, with the additional members 11 being used to relay current to elements 13 on either or one side thereof. These are only non-limiting examples and the present invention includes both these examples and other configurations which may be envisaged by one of skill in the art.

Whilst the above description has been directed towards towel rails, it would be apparent to one of skill in the art that the invention may be implemented as heaters for more general purposes, with or without modification, and it is intended that such uses or implementations and modifications be included within the scope of the invention.

Furthermore, whilst the description has been focussed on electrical heaters/towel rails, it would be clear to one of skill in the art that the teaching could be modified to be applied to hydronic heaters/towel rails and it is intended that such modifications be included within the scope of the invention. In particular, the means for coupling the (generally, but not limited to, horizontal) one or more elements to the (generally, but not limited to, vertical) one or more members may comprise means for sealably coupling the elements to the members such that heated liquid may circulate through the member(s) and the element(s), without leaking, when they are slotted together.

It should further be noted that various changes and modifications to the presently preferred embodiments described herein will be apparent to those skilled in the art. Such changes and modifications may be made without departing from the spirit and scope of the present invention and without diminishing its attendant advantages. It is therefore, intended that such changes and modifications be included within the present invention.

1. A member for an electrical heating apparatus, the member comprising coupling means for structurally and electrically coupling one or more elements to the member.

2. The member of claim 1, comprising means for connecting to an electrical power supply.

3. The member of claim 2, wherein the member has first and second ends, and the means for connecting is provided proximate the first end.

4. (canceled)

5. The member of claim 3, wherein the means for connecting is provided proximate the first end and the second end.

6. The member of claim 3 comprising means for conducting electrical current.

7. The member of claim 6, wherein the means for conducting is electrically couplable to the coupling means and the means for connecting.

8. The member of claim 7, wherein the means for conducting runs substantially the entire length of the member.

9. The member of claim 8, wherein the means for conducting comprises first and second conductive strips configured for electrically coupling to a plug of the element.

10. The member of claim 8, comprising at least one conductive pin coupled to the means for conducting, the at least one pin being configured to mate with a socket provided in the element.

11. An element for an electrical heating apparatus, the element comprising means for cooperating with coupling means of at least one member for an electrical heating apparatus so as to structurally and electrically couple the element to the at least one member.

12. The element of claim 11, comprising resistance wire heating means electrically coupled to the means for cooperating.

13. The element of claim 12, comprising first and second ends, wherein the means for cooperating is provided proximate said first end of the element.

14. The element of claim 13, wherein the means for cooperating is provided proximate the second end of the element.

15. The element of any one of claims 11 to 14, wherein the means for cooperating comprises a plug configured to electrically couple to a socket in the member.

16. The element of any one of claims 11 to 14, wherein the means for cooperating comprises a socket configured to electrically couple to a plug in the member.

17. An apparatus comprising:
at least one member for an electrical heating apparatus, the at least one member comprising coupling means for structurally and electrically coupling one or more elements to the at least one member; and
at least one element for an electrical heating apparatus, the at least one element comprising means for cooperating with the coupling means so as to structurally and electrically couple the at least one element to the at least one member.

18. The apparatus of claim 17, comprising two said members, wherein each said element is electrically coupled to at least one of the members and structurally supported by both said members.

19. An electrical heater comprising a plurality of points at which the heater may be connected to a power supply.

20. The electrical heater of claim 19, comprising at least one member for an electrical heating apparatus, the at least one member comprising coupling means for structurally and electrically coupling one or more elements to the member.

21. The electrical heater of claim 20, comprising at least one element for an electrical heating apparatus, the at least one element comprising means for cooperating with the coupling means so as to structurally and electrically couple the element to one or more members.

22.-25. (canceled)
